(19) United States
(12) Patent Application Publication
(10) Pub. No.: US 2008/0187257 A1
(43) Pub. Date: Aug. 7, 2008

(54) Spindle motor having a fluid dynamic bearing system

(76) Inventors: Martin Engesser, Donaueschingen (DE); Stefan Schwamberger, Hermsdorf (DE)

Correspondence Address: COOPER & DUNHAM, LLP, 1185 AVENUE OF THE AMERICAS, NEW YORK, NY, 10036, US

(21) Appl. No.: 12/012,428

(22) Filed: Feb. 1, 2008

(30) Foreign Application Priority Data
Feb. 3, 2007 (DE) 10 2007 005 516.3

(51) Int. Cl. F16C 32/06

(52) U.S. Cl. 384/107

(57) ABSTRACT

The invention relates to a spindle motor having a fluid dynamic bearing system that comprises a base (10), a stationary shaft (14) that is connected to the base (10), a bearing bush (16) that is connected to the base (10) and disposed at a spacing about the shaft (14), a hub (18) having a sleeve-shaped part (20) and a cylindrical bore for receiving the shaft (14), a thrust plate (22)) that is disposed at one end of the sleeve-shaped part (20; 120), wherein the sleeve-shaped part and the thrust plate are disposed between an inside circumference of the bearing bush (16) and the outside circumference of the shaft (14). A bearing gap (24) containing bearing fluid is provided between the mutually opposing surfaces of the shaft (14), the hub (18), the thrust plate (22) and the bearing bush (16) that fully encloses the sleeve-shaped part (20) and the thrust plate (22) and has two open ends, there is at least one fluid dynamic radial bearing (36; 38) formed by the associated bearing surfaces of the shaft (14) and the hub (18) or the sleeve-shaped part (20), at least one fluid dynamic axial bearing (40; 42) formed by the associated bearing surfaces of the thrust plate (22), the base (10) and/or the bearing bush (16), and an electromagnetic drive system (32; 34).

### BACKGROUND OF THE INVENTION

The invention relates to a spindle motor having a fluid dynamic bearing system used particularly for hard disk drives.

### PRIOR ART

Spindle motors having fluid dynamic bearing systems can essentially be divided into two different groups: motors having a rotating shaft and a bearing system that is usually open at only one end (e.g. a so-called single plate design having an axial bearing at one end) and motors having a stationary shaft and a bearing system open at both ends.

One advantage provided by the first group of motors is that they can be manufactured relatively easily and at low-cost. A disadvantage is their limited mechanical stability since the bearing cannot be connected to the housing at both ends. A bearing of this kind is revealed in DE 102 39 650 B3.

An advantage afforded by the second group of motors is the possibility of connecting the stationary shaft of the spindle motor to the housing not only at one end alone, but also of fixing it at the other end to the top cover of the housing. These types of motors thus acquire considerably greater structural stiffness compared to motors having rotating shafts, making them particularly suitable for hard disk drives having special requirements, such as a large number of storage disks and a high number of revolutions for servers or for laptops that are subject to more frequent or stronger vibrations during normal operation.

A type of spindle motor having a stationary shaft fixed at both ends that is in widespread use is a motor having a conical bearing. This kind of bearing comprises two conical parts (cones) that are connected to a stationary shaft. The rotor commonly consists of two bearing bushes separated axially from one another by an elastomer, the bearing bushes being correspondingly inversely tapered at their inside diameter and connected to a hub at their outside diameter. A bearing gap is formed between the cones and the tapered regions of the bearing bushes forming an angle of approximately 30° to the rotational axis. The manufacture of such motors having a stationary shaft and conical bearing is both complex and expensive.

### SUMMARY OF THE INVENTION

The object of the invention is to provide a spindle motor having a fluid dynamic bearing system that substantially combines the advantages of motors having a single plate design with those having a stationary shaft fixed at both ends.

This object has been achieved according to the invention by the characteristics outlined in independent claim 1.

Preferred embodiments and further advantageous characteristics of the invention are revealed in the subordinate claims.

The spindle motor having a fluid dynamic bearing system according to the invention comprises a base, a stationary shaft that is connected to the base, a bearing bush that is connected to the base and disposed at a spacing about the shaft, a hub having a sleeve-shaped part and a cylindrical bore for receiving the shaft, and a thrust plate that is disposed at one end of the sleeve-shaped part, the sleeve-shaped part and the thrust plate being disposed between an inside circumference of the bearing bush and the outside circumference of the shaft. There is further a bearing gap between the mutually opposing surfaces of the shaft, the hub, the thrust plate and the bearing bush, the bearing gap fully enclosing the sleeve-shaped part and the thrust plate and having two open ends. Also provided is at least one fluid dynamic radial bearing formed by the associated bearing surfaces of the shaft and of the hub and/or of the sleeve-shaped part and/or between the associated bearing surfaces of the sleeve-shaped part and the bush, at least one fluid dynamic axial bearing formed by the associated bearing surfaces of the thrust plate, the base and the bearing bush, and an electromagnetic drive system.

The advantages of the spindle motor according to the invention are obvious. The possibility of connecting both ends of the stationary shaft to the housing or to the base respectively considerably increases the mechanical stability and stiffness of the bearing system compared to a bearing system having a rotating shaft. The technically mature and constructionally rather simple principle of the single plate design can nevertheless be maintained, thus allowing this kind of spindle motor to be assembled at low cost, since only a few costly machined parts are required.

Unlike conventional motors having a single plate design, the present invention involves a bearing having two open ends, i.e. the bearing gap is open to the surrounding atmosphere at both ends.

Due to the sleeve-shaped part of the hub, which is disposed between the shaft and the bearing bush, a bearing gap is produced that has an inner section between the shaft and the hub or the sleeve-shaped part respectively, and an outer section between the sleeve-shaped part and the bearing bush. Both the open end of the inner section of the bearing gap as well as the open end of the outer section of the bearing gap is sealed by a capillary seal. At the end of the inner section of the bearing gap, a capillary seal having a sealing groove, for example, can be used. At the end of the outer section of the bearing gap, a tapered capillary seal, i.e. an extension of the bearing gap having a conical cross-section, is preferably provided. Due to its enlarged volume, this tapered seal can also act as a reservoir for the bearing fluid.

At least one channel extending substantially in an axial direction can further be disposed in the hub and/or the sleeve-shaped part, the channel acting as a recirculation channel and connecting the inner section of the bearing gap to the outer section of the bearing gap. This allows the bearing fluid to circulate freely within the two sections of the bearing gap. On at least one end of the bearing gap, preferably at the end at which the tapered seal is provided, an active pumping seal can further be provided, the pumping seal being defined by pumping patterns formed between the bearing bush and hub. These pumping patterns support the sealing effect of the capillary seal and the circulation of the bearing fluid in the two sections of the bearing gap.

In place of the capillary seals, active pumping seals alone may be provided as an alternative, such as are also known in the prior art and therefore not described in more detail here. A person skilled in the art would thus easily be able to determine the position and design of the pumping patterns in the bearing gap.

Preferably disposed on the base is a mounting plate that is formed either as an integrated part of the base or as a separate part, the mounting plate sealing one end of the bearing bush and the shaft being held in the mounting plate.

To improve the circulation of the bearing fluid around the thrust plate, the thrust plate may have at least one bore that connects the opposing end faces of the thrust plate to each other.

### BRIEF DESCRIPTION OF THE DRAWINGS

FIG. 1 shows a sectioned view of a first embodiment of a spindle motor according to the invention having a fluid dynamic bearing system.

FIG. 2 shows a sectioned view of a second embodiment of a spindle motor according to the invention having a fluid dynamic bearing system.

### DESCRIPTION OF PREFERRED EMBODIMENTS OF THE INVENTION

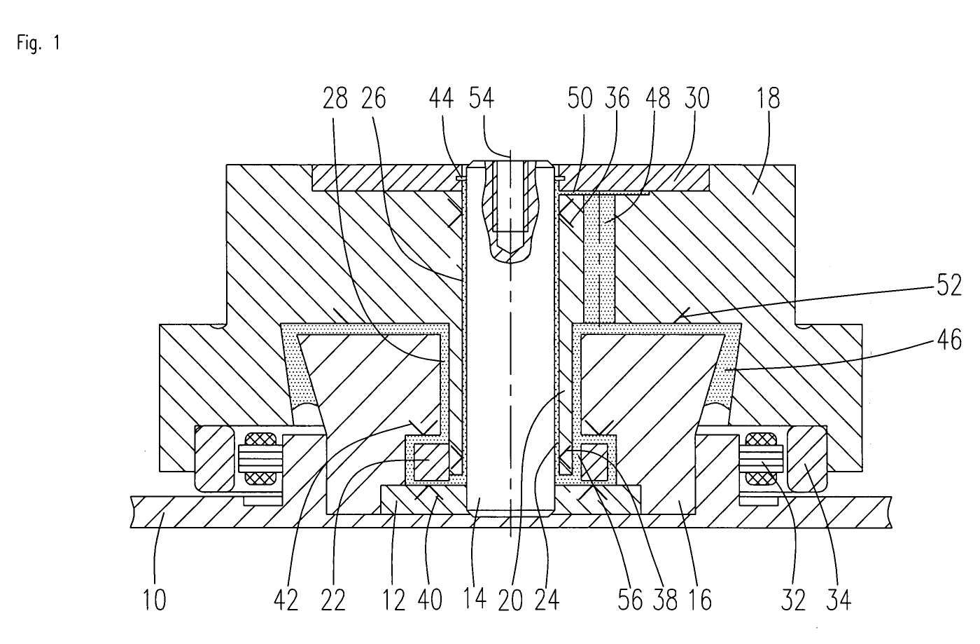

FIG. 1 shows a spindle motor according to the invention that comprises a base 10 taking the form of a baseplate or a base flange. The baseplate 10 has an annular rim into which a bearing bush 16 is pressed or bonded. The lower end of the bearing bush 16, which abuts the base 10, is sealed by a mounting plate 12. The mounting plate 12 has a central bore in which a shaft 14 is held. The hub 18 of the motor is approximately cup-shaped in cross-section and has a central bore in which the shaft 14 is accommodated. The hub 18 comprises a sleeve-shaped part 20 that is integrally formed as one piece with the hub and disposed between the outside circumference of the shaft 14 and the inside circumference of the bearing bush 16. A thrust plate 22 is attached to the free end of the sleeve-shaped part 20. The thrust plate 22 is located in a recess defined by the bearing bush 16, the mounting plate 12 and the sleeve-shaped part 20.

The hub 18 is rotatably supported about the shaft 14. For this purpose, two fluid dynamic radial bearings 36, 38 are provided, the fluid dynamic radial bearings being formed by the respective, mutually opposing bearing surfaces of the shaft 14 and the hub 18 or the sleeve-shaped part 20 respectively. The bearing surfaces of the shaft 14 and the hub 18 or the part 20 respectively are separated from one another by a bearing gap 24, more precisely by an inner section 26 of the bearing gap. The bearing gap 24 is filled with bearing fluid and hydrodynamic pressure is built up in the fluid owing to the fact that the radial bearings 36, 38 have radial bearing patterns that exert a pumping effect on the bearing fluid as soon as the hub 18 rotates about the shaft 14.

At one end, the inner section 24 of the bearing gap 26 is sealed by an annular groove that acts as a capillary seal 44. The other end of the inner section 24 of the bearing gap continues in the direction of the thrust plate 22. The bearing gap 24 encloses the thrust plate 22, two hydrodynamic thrust bearings (axial bearings) being provided in the region of the thrust plate 22. One axial bearing is formed by a lower bearing surface of the thrust plate 22 and an opposing bearing surface of the mounting plate 12. At least one of these bearing surfaces is provided with a bearing pattern in order to produce a hydrodynamic effect when the thrust plate 22 rotates together with the hub 18. A second axial bearing 42 is formed by an upper bearing surface of the thrust plate 22 and an opposing bearing surface of the bearing bush 16. From this axial bearing region, the bearing gap 24 now continues into an outer section 28, wherein the width of the bearing gap in the outer section 28 may be larger than in the inner section 26, since preferably no bearing patterns are provided in the outer section 28.

Starting from the thrust plate 22, both the outer section 28 of the bearing gap as well as the inner section 26 extend in an axial direction approximately over the length of the sleeve-shaped part. A radially extending section of the outer bearing gap 28 then follows, the radial section being provided between the adjacent surfaces of the bearing bush 16 and of the hub 18. The outer section 28 of the bearing gap circles the upper part of the bearing bush 16 and then continues in an axial direction where it forms a tapered seal 46 between the outside circumference of the bearing bush 16 and an inside circumference of the rim of the cup-shaped hub 18. The conical cross-section of the capillary seal 46 is produced by slanted surfaces of the bearing bush and/or of the hub.

Appropriate pumping patterns 52 disposed in the radial region of the bearing gap section 28 may support the sealing effect of the capillary seal 46.

Due to the interlaced structure of the bearing gap 24, i.e. through its division into an inner section 26 and an outer section 28, which again has two axial and one radial section, it is possible to dispose the two radial bearings 36 and 38 at the greatest possible distance from one another despite the low overall height of the bearing. This has a positive effect on bearing stiffness. Moreover, due in particular to the relatively large quantity of bearing fluid in the outer section 28 of the bearing gap 24 as well as in the sealing region 46, a large reservoir can be created that ensures a supply of bearing fluid over a long period of time. This makes the motor suitable for use in high temperature ranges since the bearing fluid evaporating owing to the temperature can be replaced from the reservoir in sufficient quantities.

In order to ensure the circulation of the bearing fluid between the inner section 26 and the outer section 28 of the bearing gap 24, a channel 48 extending in an axial direction is provided in the hub 18, the channel connecting the outer section 28 of the bearing gap 24 to a channel 50 that runs into the region of the capillary seal 44 in the inner section 26 of the bearing gap 24. In the region of the channel 50, the hub 18 preferably has a recess that is closed by a cover 30. The channel 50 is formed between the hub 18 and the cover 30. Furthermore, the annular groove that forms the capillary seal 44 is also provided in the cover 30. With no impediment to its function, the annular groove could also be formed in the shaft.

The rotor drive, i.e. the hub 18, is realized in a conventional manner by an electromagnetic drive system. The drive system consists of a stator arrangement 32 that is disposed in the outer region of the base. Lying opposite this stator arrangement 32 is a rotor magnet 34 fixed to the hub 18.

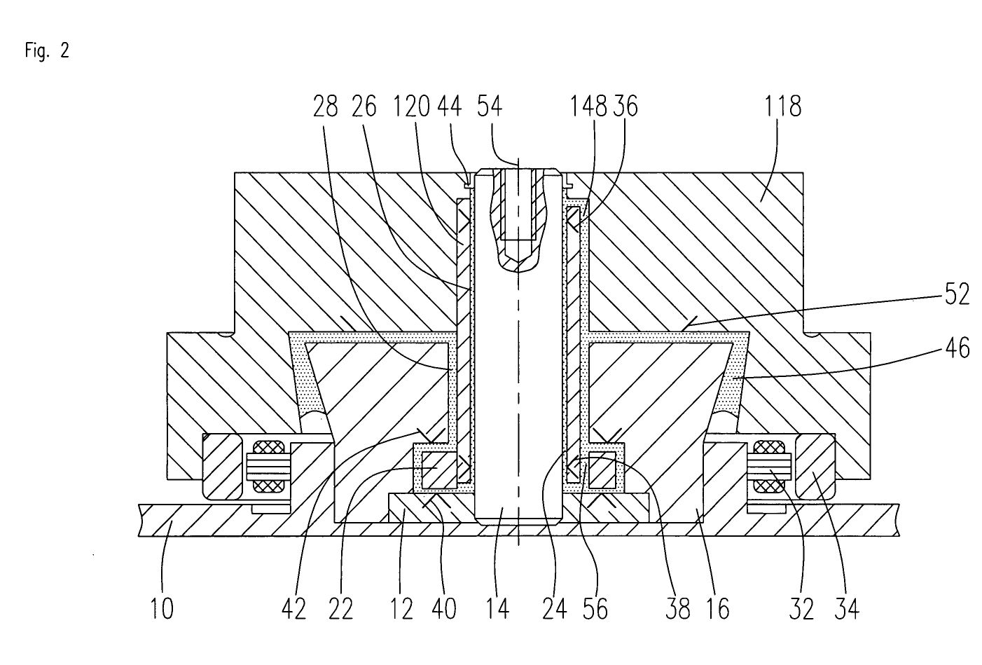

FIG. 2 shows an embodiment of the spindle motor modified vis-à-vis FIG. 1. Most of the components of the spindle motor of FIG. 2 are identical to the spindle motor in FIG. 1, identical components being indicated by the same reference numbers.

In contrast to FIG. 1, a two-piece hub is provided in the spindle motor according to FIG. 2 that is made up of the hub 118 itself and a separate sleeve-shaped part 120 connected to the hub. The sleeve-shaped part 120 corresponds in shape and function to the sleeve-shaped part of FIG. 1. According to FIG. 2, the sleeve-shaped part 120 is machined separately from the hub 118 and includes in particular the bearing patterns for the two radial bearings 136 and 138. The thrust plate 22 is further fixed to the free end of the part 120.

A channel 148 for the circulation of the bearing fluid between the inner section 26 and the outer section 28 of the bearing gap 24 is formed by recesses between the hub 118 and the sleeve-shaped part 120.

It is of course possible to form the sleeve-shaped part 120 integrally with the hub 118. In this case, the channel 148 has to be provided in the hub 118 as an appropriate axial and radial bore. Similarly, it is also possible to form the sleeve-shaped part 120 and the thrust plate 22 integrally as one piece.

In the case of this hub 118, a cover, as illustrated in FIG. 1, is omitted since the two-piece design of the hub 118 and the sleeve-shaped part 120 makes it possible to introduce a channel 148 without any problem at all. The annular groove of the capillary seal 44 is then provided directly in the hub 118.

### Identification Reference List

10 Base
12 Mounting plate
14 Shaft
16 Bearing bush
18 Hub
20 Sleeve-shaped part
22 Thrust plate
24 Bearing gap
26 Inner section (bearing gap)
28 Outer section (bearing gap)
30 Cover
32 Stator arrangement
34 Rotor magnet
36 Radial bearing
38 Radial bearing
40 Axial bearing
42 Axial bearing
44 Capillary seal
46 Capillary seal
48 Channel
50 Channel
52 Pumping seal
54 Rotational axis
56 Bore
118 Hub
120 Sleeve-shaped part
148 Channel

1. A spindle motor having a fluid dynamic bearing system comprising:
a base (10),
a stationary shaft (14) that is connected to the base (10),
a bearing bush (16) that is connected to the base (10) and disposed at a spacing about the shaft (14),
a hub (18; 118) having a sleeve-shaped part (20; 120) and a cylindrical bore for receiving the shaft (14),
a thrust plate (22) that is disposed at one end of the sleeve-shaped part (20; 120), wherein the sleeve-shaped part and the thrust plate are disposed between an inside circumference of the bearing bush (16) and the outside circumference of the shaft (14),
a bearing gap (24) containing bearing fluid between the mutually opposing surfaces of the shaft (14), the hub (18; 118), the thrust plate (22) and the bearing bush (16) that fully encloses the sleeve-shaped part (20; 120) and the thrust plate (22) and has two open ends,
at least one fluid dynamic radial bearing (36; 38) formed by associated bearing surfaces of the shaft (14) and the hub (18;118) or the sleeve-shaped part (20; 120),
at least one fluid dynamic axial bearing (40; 42) formed by associated bearing surfaces of the thrust plate (22), the base (10) and the bearing bush (16), and
an electromagnetic drive system (32; 34).

2. A spindle motor according to claim 1, characterized by at least one further radial bearing formed by the associated bearing surfaces of the sleeve-shaped part (20; 120) and of the bearing bush (16).

3. A spindle motor according to claim 1, characterized in that the bearing gap (24) has an inner section (26) disposed between the shaft (14) and the hub (18; 118) or the sleeve-shaped part (20; 120) and an outer section (28) disposed between the sleeve-shaped part (20; 120) and the bearing bush (16).

4. A spindle motor according to claim 1, characterized in that the two open ends of the bearing gap (24) are each sealed by a capillary seal (44; 46).

5. A spindle motor according to claim 4, characterized in that one capillary seal comprises a sealing groove (44).

6. A spindle motor according to claim 4, characterized in that one capillary seal (46) is designed as a capillary seal having a conical cross-section.

7. A spindle motor according to claim 3, characterized in that the inner section (26) of the bearing gap (24) is connected to the outer section (28) of the bearing gap (24) by at least one channel (48, 50; 148) filled with bearing fluid.

8. A spindle motor according to claim 7, characterized in that the channel (48, 50; 148) is disposed in the hub and/or the sleeve-shaped part (120).

9. A spindle motor according to claim 1, characterized in that at one end of the bearing gap (24) an active pumping seal (52) is provided that is defined by pumping patterns formed between the bearing bush (16) and the hub (20; 120).

10. A spindle motor according to claim 1, characterized in that a mounting plate (12) is disposed on the base (10), the mounting plate sealing one end of the bearing bush (16) and the shaft (14) being held in the mounting plate.

11. A spindle motor according to claim 1, characterized in that the thrust plate (22) has at least one bore (56) that connects the opposing end faces of the thrust plate to each other.

12. A spindle motor according to claim 1, characterized in that the sleeve-shaped part (120) is formed as a separate part of the hub (118).
